(19) United States
(12) Patent Application Publication
(10) Pub. No.: US 2025/0008930 A1
(43) Pub. Date: Jan. 9, 2025

(54) A MACHINE VISION SYSTEM FOR LARVAL AQUATIC ANIMAL REARING

(71) Applicant: RAMOT AT TEL-AVIV UNIVERSITY LTD., Tel Aviv (IL)

(72) Inventors: Roi HOLZMAN, Tel Aviv (IL); Shmuel AVIDAN, Tel Aviv (IL)

(21) Appl. No.: 18/704,168

(22) PCT Filed: Oct. 27, 2022
(86) PCT No.: PCT/IL2022/051139

§ 371 Date: Sep. 19, 2024

Related U.S. Application Data
(60) Provisional application No. 63/272,195, filed on Oct. 27, 2021.

(51) Int. Cl. A01K 29/00; A01K 61/10; G06V 10/147; G06V 10/82; G06V 20/40; G06V 20/52; G06V 40/10; G06V 40/20; H04N 23/51; H04N 23/56

(52) U.S. Cl. CPC A01K 29/005; A01K 61/10; G06V 10/147; G06V 10/82; G06V 20/41; G06V 20/44; G06V 20/52; G06V 40/10; G06V 40/20; H04N 23/51; H04N 23/56

(57) ABSTRACT

A machine vision system for larval aquatic animal rearing constituted of a video camera, a watertight housing and a processor, wherein the video camera is arranged to continuously capture video of a predetermined volume and transmit the captured video to the processor, and wherein the processor is arranged to apply one or more neural networks to the captured video to: isolate individual aquatic animal within the video: identify at least one predetermined activity parameter and/or at least one predetermined morphological anomaly of the isolated aquatic animal.

### TECHNICAL FIELD

The present disclosure relates substantially to the field of larval aquatic animal rearing.

### BACKGROUND

Quantitative analysis of animal movements constitutes an important tool in understanding the relationship between animal form and function, and how animals perform tasks that affect their chances of survival.

This discipline benefited greatly when filming technology enabled the freezing of fast movements and determination of the sequence of events that occur when animals move. Stroboscopic filming and multiple cameras, first used in the early 1900s, have evolved to designated 16 mm movie cameras capable of filming at hundreds of frames per second. In the last decades, digital high-speed videography has enabled the collection of detailed kinematics of animal motion, however analysis is often focused on short video clips, usually <1 s. Commonly, events of interest, such as the movement of animals while jumping, landing or striking prey, are captured on video by manually triggering the camera at the right time, and saving the relevant range within each video sequence. The data are then digitized and analyzed to resolve temporal patterns in the sequence of events, variables such as speed and acceleration, and other quantitative kinematic data. This framework has enabled researchers to understand the mechanistic and behavioral aspects of diverse behaviors such as jumping, flying, running, gliding, feeding and drinking in many animal species.

Manually triggering the camera to save short sequences is only suitable for events that can be easily identified in real time, are easy to induce, or are repetitive and frequent. For events that do not adhere to these criteria or that are unpredictable in space and time, manual triggering and saving short clips limits the possible scope of research and analysis. Some examples of the latter constraint is suction feeding by larval aquatic animal. Newly hatched aquatic animal subsist on a limited supply of yolk and thus must encounter and successfully capture food before their energy resources become depleted. To capture their prey, larval aquatic animal swim towards it and then open their mouth while expanding the oral cavity. The expansion of the larvae's mouth generates a strong inward flow of water, and this flow is key to successful suction feeding, drawing the prey into the predator's mouth. However, the body of a hatchling larva is a few millimeters long, and its mouth diameter is as small as 100 μm. The high magnification optics required to film these minute larvae leads to a small depth-of-field and limited visualized area. Actively swimming larvae remain in the visualized area for only a few seconds. A low feeding rate (especially in the first days posthatching) results in a scarcity of feeding attempts in the visualized area. Similar to adults, prey capture in larvae takes a few tenths of a millisecond, easily missed by the naked eye or conventional video.

### SUMMARY

Accordingly, it is a principal object of the present invention to overcome at least some of the disadvantages of prior art larval aquatic animal rearing systems. This is provided in some examples by a machine vision system for larval aquatic animal rearing, the system comprising: a high-speed video camera comprising a lens, the lens exhibiting a high depth of field (DOF) and a microscopic resolution; a watertight housing, the high-speed video camera positioned within the watertight housing; and a processor in communication with the high-speed video camera, wherein the high-speed video camera is arranged to continuously capture video of a predetermined volume and transmit the captured video to the processor, and wherein the processor is arranged to apply one or more neural networks to the captured video to: isolate individual aquatic animal within the video; identify at least one predetermined activity parameter and/or at least one predetermined morphological anomaly of the isolated aquatic animal; and output the identified at least one predetermined activity parameter and/or the at least one predetermined morphological anomaly of the isolated aquatic animal.

In some examples, the high-speed video camera captures images at a speed of at least 250 frames per second. In one further example, the high-speed video camera captures images at a speed of at least 750 frames per second.

In some examples, the high DOF allows to continuously capture video from at least 125 cm3 of water. In some examples, the lens comprises a telecentric lens.

In some examples, the housing is positioned about 5 cm away from the predetermined volume. In some examples, at least a portion of the housing is transparent.

In some examples, the system further comprises a light emitting diode (LED) backlit illumination panel, the illumination panel positioned between the housing and the predetermined volume, wherein the illumination panel is submersible. In one further example, the illumination panel is arranged such that light from the illumination panel is collimated to the direction of the camera.

In some examples, the system further comprises a semi-transparent diffuser, the diffuser positioned such that the housing and the diffuser are on opposing sides of the predetermined volume. In some examples, the processor is arranged to receive 10-20 minutes of video from the video camera.

In some examples, the one or more neural networks comprises a plurality of SlowFast networks. In some examples, the at least one predetermined activity parameter is selected from the group consisting of: cohort size; activity level; feeding performance; and food preference.

In some examples, the at least one predetermined morphological anomaly is selected from the group consisting of: abnormal body length; non-development of swim bladder; and skeletal aberrations.

In one independent example, a machine vision method for larval aquatic animal rearing is provided, the method comprising: submersing in water a watertight housing containing a high-speed video camera comprising a lens, the lens exhibiting a high depth of field (DOF) and a microscopic resolution; continuously capturing video of a predetermined volume of the water for a predetermined amount of time; and applying one or more neural networks to the captured video to: isolate individual aquatic animal within the video, identify at least one predetermined activity parameter and/or at least one predetermined morphological anomaly of the isolated aquatic animal, and output the identified at least one predetermined activity parameter and/or the at least one predetermined morphological anomaly of the isolated aquatic animal.

In some examples, the high-speed video camera captures images at a speed of at least 250 frames per second. In one further example, the high-speed video camera captures images at a speed of at least 750 frames per second. In some examples, the high DOF allows to continuously capture video from at least 125 cm3 of water.

In some examples, the lens comprises a telecentric lens. In some examples, the method further comprises positioning the housing about 5 cm away from the predetermined volume.

In some examples, at least a portion of the housing is transparent. In some examples, the method further comprises: submersing a light emitting diode (LED) backlit illumination panel in the water, the illumination panel positioned between the housing and the predetermined volume; and providing light from the submersed LED backlit illumination panel.

In some examples, the method further comprises collimating the provided light with a direction of the camera. In some examples, the method further comprises submersing a semi-transparent diffuser in the water, the diffuser positioned such that the housing and the diffuser are on opposing sides of the predetermined volume.

In some examples, the processor is arranged to receive 10-20 minutes of video from the video camera. In some examples, the one or more neural networks comprises a plurality of SlowFast networks.

In some examples, the at least one predetermined activity parameter is selected from the group consisting of: cohort size; activity level; feeding performance; and food preference. In some examples, the at least one predetermined morphological anomaly is selected from the group consisting of: abnormal body length; non-development of swim bladder; and skeletal aberrations.

Additional features and advantages of the invention will become apparent from the following drawings and description.

Unless otherwise defined, all technical and scientific terms used herein have the same meaning as commonly understood by one of ordinary skill in the art to which this invention pertains. In case of conflict, the patent specification, including definitions, governs. As used herein, the articles “a” and “an” mean “at least one” or “one or more” unless the context clearly dictates otherwise. As utilized herein, “and/or” means any one or more of the items in the list joined by “and/or”. As an example, “x and/or y” means any element of the three-element set {(x), (y), (x, y)}. In other words, “x and/or y” means “x, y or both of x and y”. As some examples, “x, y, and/or z” means any element of the seven-element set {(x), (y), (z), (x, y), (x, z), (y, z), (x, y, z)}.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of examples of the instant inventive concepts. This is done merely for convenience and to give a general sense of the inventive concepts, and “a” and “an” are intended to include one or at least one and the singular also includes the plural unless it is obvious that it is meant otherwise.

As used herein, the term “about”, when referring to a measurable value such as an amount, a temporal duration, and the like, is meant to encompass variations of +/−10%, more preferably +/−5%, even more preferably +/−1%, and still more preferably +/−0.1% from the specified value, as such variations are appropriate to perform the disclosed devices and/or methods.

The following examples and aspects thereof are described and illustrated in conjunction with systems, tools and methods which are meant to be exemplary and illustrative, but not limiting in scope. In various examples, one or more of the above-described problems have been reduced or eliminated, while other examples are directed to other advantages or improvements.

### BRIEF DESCRIPTION OF DRAWINGS

For a better understanding of the invention and to show how the same may be carried into effect, reference will now be made, purely by way of example, to the accompanying drawings in which like numerals designate corresponding sections or elements throughout.

With specific reference now to the drawings in detail, it is stressed that the particulars shown are by way of example and for purposes of illustrative discussion of the preferred examples of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how several forms of the invention may be embodied in practice. In the accompanying drawings:

FIG. 1 illustrates a high-level schematic diagram of an example of a machine vision system for larval aquatic animal rearing;

FIG. 2 illustrates a high-level schematic diagram of a more detailed example of the system of FIG. 1; and

FIG. 3 illustrates a high-level flow chart of an example of a machine vision method for larval aquatic animal rearing.

### DETAILED DESCRIPTION OF CERTAIN EXAMPLES

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure. In the figures, like reference numerals refer to like parts throughout. In order to avoid undue clutter from having too many reference numbers and lead lines on a particular drawing, some components will be introduced via one or more drawings and not explicitly identified in every subsequent drawing that contains that component.

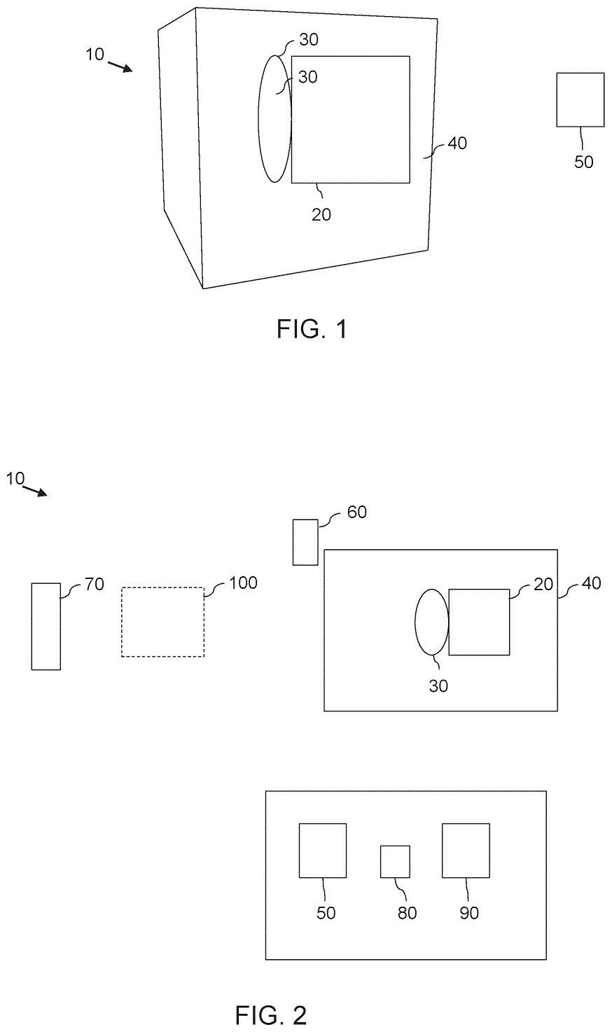

FIG. 1 illustrates a high-level schematic diagram of an example of a machine vision system 10 for larval aquatic animal rearing. The term “aquatic animal”, as used herein, means any animal which primarily lives under water. In some examples, the aquatic animal is fish. Machine vision system 10 comprises: a camera 20 comprising a lens 30; a housing 40; and a processor 50.

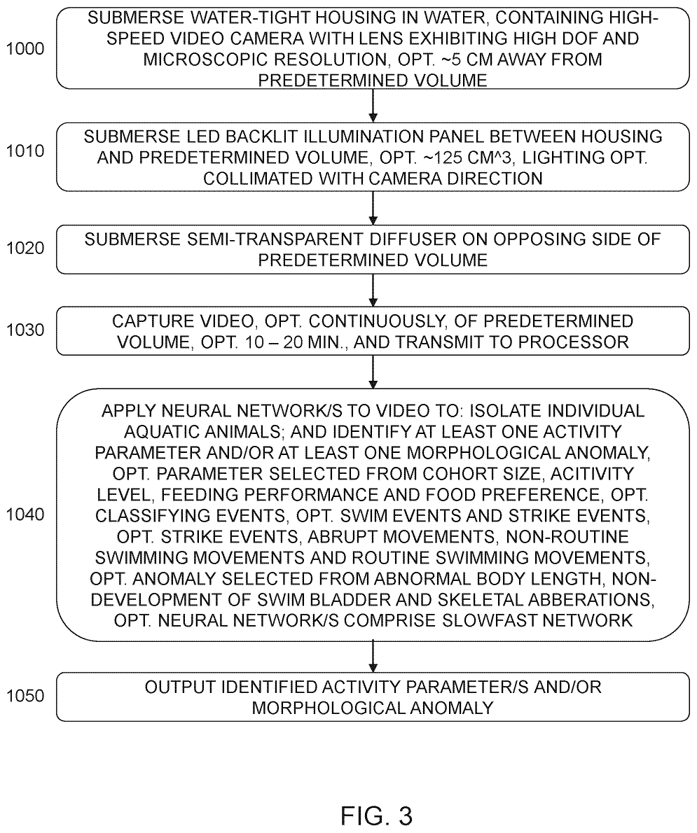

FIG. 2 illustrates a high-level schematic diagram of a more detailed example of machine vision system 10. In such an example, machine vision system 10 further comprises: a light emitting diode (LED) backlit illumination panel 60; a diffuser 70; a memory 80; and a user output device 90. FIG. 3 illustrates a high-level flow chart of an example of a machine vision method for larval aquatic animal rearing, FIGS. 1-3 being described together.

In some examples, camera 20 is a monochrome camera. In some examples, camera 20 is a video camera. In some examples, camera 20 is a high-speed camera. The term “high-speed”, as used herein, means that images are captured faster than 240 frames per second (240 fps). In some examples, camera 20 captures images at a speed of at least 250 fps. In some examples, camera 20 captures images at a speed of at least 500 fps. In some examples, camera 20 captures images at a speed of at least 750 fps. In some examples, camera 20 exhibits a resolution of 1920×1080 pixels.

In some examples, lens 30 exhibits a high depth of field (DOF) and a microscopic resolution. In one further example, the term “high DOF”, as used herein, means that lens 30 can provide a field of view of at least 125 cm³, optionally 5 cm×5 cm×5 cm. In another further example, the term “microscopic resolution”, as used herein, means a resolution of less than 1 mm, optionally less than 1 μm. In some examples, lens 30 is a telecentric lens.

In some examples, housing 40 is watertight. The term “watertight”, as used herein, means that water cannot enter. In some examples, at least a portion of housing 40 is transparent. In some examples, camera 20 and lens 30, are positioned within housing 40. In one further example, lens 30 is positioned at least 5 cm away from a wall of housing 40. In some examples, as described in stage 1000 of FIG. 3, when submersed within water, housing 40 is positioned about 5 cm away from a predetermined volume 100 of water. As a result, the optical scattering within the water will be minimized, since a majority of the optical path will be inside watertight housing 40.

In some examples, as described in stage 1010 of FIG. 3, LED backlit illumination panel 60 is submersed in the water and provides illumination to predetermined volume 100 of water. In some examples, LED backlit illumination panel 60 is positioned between housing 40 and predetermined volume 100 of water. In some examples, the light provided by LED backlit illumination panel 60 is collimated with the direction of camera 20, optionally collimated with the center of the angle of view of camera 20.

In some examples, diffuser 70 is semi-transparent. In some examples, as described in stage 1020 of FIG. 3, diffuser 70 is submersed in the water and is positioned on the other side of predetermined volume 100 of water such that housing 40 and diffuser 70 are on opposing sides of predetermined volume 100 of water.

In some examples, processor 50 is in communication with camera 20, optionally via wired, or wireless, communication. In some examples, processor 50 is in communication with memory 80. In some examples, processor 50 and memory 80 are external to housing 40.

In some examples, as described in stage 1030, camera 20 continuously captures video of predetermined volume 100 and transmits the captured video to processor 50. In some examples, the captured video is further stored in memory 80. In some examples, camera 20 provides 10-20 minutes of captured video, which is optionally stored in memory 80.

In some examples, as described in stage 1040, processor 50 applies one or more neural networks to the captured video, i.e. enters the captured video in the one or more neural networks. In some examples, the one or more neural networks comprise one or more 3D convolutional neural networks (3D-ConvNets). In some examples, the one or more neural networks comprise one or more SlowFast networks. A SlowFast network, developed by Facebook® AI research, exhibits: a slow pathway, operating at a low frame rate, to capture spatial semantics; and a fast pathway, operating a higher frame rate, to capture motion at fine temporal resolution. In some examples, the one or more neural networks comprise one or more Two-Stream, I3D or P3D neural networks.

Two-Stream and I3D models utilize optical flow as an additional input stream into the network to capitalize on fine-grained motion data. SlowFast models also employ a two-stream architecture. However, rather than using pre-computed optical flow, SlowFast varies the sampling rate of the input video in each of the streams in order to facilitate the learning of different features. The two streams are homologous except for their channel depth and sampling rates. The Slow pathway samples at a lower frequency but has a deeper structure, aimed at capturing spatial features. The Fast pathway samples more frames but has fewer channels in every block, aimed at targeting motion features. In some examples, the one or more neural networks are applied to: isolate individual aquatic animal within the video; and identify at least one predetermined activity parameter and/or at least one predetermined morphological anomaly of the isolated aquatic animal. In some examples, the at least one predetermined activity parameter is selected from the group consisting of: cohort size; activity level; feeding performance, e.g. the amount of food consumed within a predetermined time period; and food preference, e.g. the percentages of different types of foods that make up the diet of the larvae. In some examples, the at least one predetermined morphological anomaly is selected from the group consisting of: abnormal body length; non-development of swim bladder; and skeletal aberrations.

In some examples, as described in stage 1050, the identified at least one predetermined activity parameter and/or the at least one predetermined morphological anomaly of the isolated aquatic animal is output, optionally to user output device 90. In some examples, user output device 90 comprises a display such that a user can view the results of the analysis. In some examples, the identified at least one predetermined activity parameter and/or the at least one predetermined morphological anomaly of the isolated aquatic animal is output to an external system. In some examples, the identified at least one predetermined activity parameter and/or the at least one predetermined morphological anomaly of the isolated aquatic animal is output to another program being run on processor 50. In some examples, the identified at least one predetermined activity parameter and/or the at least one predetermined morphological anomaly of the isolated aquatic animal is output to another function being run on processor 50.

Thus, machine vision system 10 provides near real-time estimates of cohort size, activity level, feeding performance and food preferences, body length, development of swim bladder and skeletal aberrations. As such, it provides a unique tool to respond to fluctuations in brood quality and activity by adjust the conditions in the rearing pools, or terminating poor broods before the end of rearing period.

In some examples, to manually annotate the (sparse) feeding events, a trained observer watches the video at 10-30 fps and notes the time and coordinates of all foraging-related events. In some examples, “strikes” are defined as events that started with the larva assuming an S-shape position, followed by a rapid forward lunge and opening of the mouth. These events are visually distinct and represent high-effort prey-acquisition attempts that are likely to be successful. In some examples, two curated datasets are created, with two distinct levels of difficulty: balanced and naturalistic. In some examples, the classifier is trained using the balanced datasets and tested using the naturalistic datasets.

In some examples, for balanced datasets, “strike” events are manually inspected to exclude samples in which the aquatic animal appear severely blurred, occluded, or in low-contrast. In some examples, for each of the remaining visually coherent strikes, a spatially cropped square clip is extracted around the larva of interest. In some examples, each clip is also temporally cropped, starting 10 frames before the mouth opens and ending 5 frames after the mouth closes.

In some examples, for “swim” events, a methodology based on Canny edge detection is used to automatically detect potential larvae within a frame. In some examples, around each of these detections, cropped square clips are created, optionally about 200 frames in length. In some examples, to avoid biasing the dataset due to differences in clip durations between the “swim” and “strike” event classes, “swim” clips are temporarily cropped at random, in order to match the distribution of clip duration in the “strike” class.

In some examples, a predetermined number of clips comprising “strike” events and a predetermined number of clips comprising “swim” events are selected to obtain a balanced dataset design between the two action classes.

In some examples, for naturalistic datasets, a predetermined algorithm is applied, as will be described below. In some examples, the predetermined algorithm is applied to all frames known to contain strike events and to an additional predetermined number of frames sampled at random from the entire length of the video, optionally maintaining a ratio of ˜1:10 between frames that contained events of interest and those that did not. In some examples, from each frame sampled, small square clips are extracted using the predetermined algorithm described below. In some examples, for each clip in the dataset, a “strike score” is provided, i.e., the classification score output for the “strike” class, and a human annotation is provided.

In some examples, for each clip, the main activity of the aquatic animal in the clip is labeled. In some examples, these labels include any, or a combination of: swim activity (i.e. swimming movement of the aquatic animal); spit activity (i.e. the aquatic animal is spitting out something from their mouth); pre-strike activity (i.e. the aquatic animal is preparing to strike); no aquatic animal present; or unclear. In some examples, the labels are merged into one or more of the following categories: strikes, abrupt movements, non-routine swimming, compromised footage, routine swimming, and can't tell or no aquatic animal.

In some examples, abrupt movements refer to clips in which the larvae rapidly changed swimming direction or attempted to spit out prey items. In some examples, non-routine swimming refers to clips showing floating (no undulations of the body or fins), interrupted swimming (rapidly accelerating or decelerating), and reverse swimming.

In some examples, compromised footage refers to overexposed images, caused by the filming setup; aquatic animal appearing to move unreasonably fast in/out of frame as the result of strong local flows; and very blurry footage caused by aquatic animal being outside the focal volume. In some examples, a “Can't tell” category is used in cases in which the focal aquatic animal was occluded or the image was too dark to describe its behavior. In some examples, “No aquatic animal” refers to cases of false identification by the detection module.

In some examples, strikes are defined as rapid lunges towards the prey followed by opening of the larva's mouth. In some examples, all other samples are considered routine swimming.

In some examples, the predetermined algorithm comprises two models, trained separately: an action classifier and a aquatic animal detector. In some examples, the aquatic animal detector is used to find areas of interest within the frame (as described above), from which the clips are generated and fed to the trained classifier. In some examples, the action classifier is trained on a curated balanced dataset.

In some examples, to classify predetermined portions of the captured video (referred to hereinafter as “clips”) into “swim” and “strike” events, an action classifier is trained using a neural network, as described above. In some examples, where a SlowFast model is used, the rate at which each pathway samples frames from the input clip is a user-specified hyperparameter. In some examples the Slow pathway is set for sampling 8 frames uniformly throughout the clip, and the Fast pathway is set for sampling 32 frames throughout the clip.

In some examples, a Transfer Learning algorithm is used to fine-tune existing model weights trained on a predetermined dataset.

In some examples, where the dataset shows a diversity of visual conditions; mainly differences in lighting intensity and degree of blurriness of the aquatic animal. In some examples, in order to reduce bias derived from spurious features related to these conditions and to enhance the number of samples in the dataset, augmentation is randomly applied to the intensity values of clips, the degree of brightness is varied, and the sharpness of clips is augmented by randomly applying Gaussian blur to samples during training.

In some examples, rather than calculating the optical flow for each clip, which is computationally intensive, the variance image of the entire clip is calculated, thereby capturing areas where sudden rapid movement had occurred. In some examples, the variance image is duplicated along the temporal axis and stored as a third channel, alongside two duplicate channels of the clip's monochrome sequence.

In some examples, the predetermined algorithm comprises a detection module, followed by a classifier, as will be described below.

In some examples, for the detection module, an object detector is trained. In some examples, the object detector is a Faster-RCNN object detector, with a ResNet-50-FPN backbone, and is trained using the Detectron2 framework. In some examples, the object detector is pre-trained on ImageNet and fine-tuned on a detection dataset.

In some examples, after training the detector module, the detector module is used in conjunction with the classifier described above. In some examples, for each frame sampled, the detector was applied to locate the aquatic animal in the frame. In some examples, around each of these detections, short cropped clips centered around the putative aquatic animal are created. In some examples, the variance image of each clip is calculated and the manipulated input is fed into the action classifier in order to obtain classification scores for each clip.

It is appreciated that certain features of the invention, which are, for clarity, described in the context of separate examples, may also be provided in combination in a single example. Conversely, various features of the invention which are, for brevity, described in the context of a single example, may also be provided separately or in any suitable subcombination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and subcombinations of the various features described hereinabove as well as variations and modifications thereof which would occur to persons skilled in the art upon reading the foregoing description.

1. A machine vision system for larval aquatic animal rearing, the system comprising:
a high-speed video camera comprising a lens, the lens exhibiting a high depth of field (DOF) and a microscopic resolution;
a watertight housing, the high-speed video camera positioned within the watertight housing; and
a processor in communication with the high-speed video camera,
wherein the high-speed video camera is arranged to continuously capture video of a predetermined volume and transmit the captured video to the processor, and
wherein the processor is arranged to apply one or more neural networks to the captured video to:
isolate individual aquatic animal within the video;
identify at least one predetermined activity parameter and/or at least one predetermined morphological anomaly of the isolated aquatic animal; and
output the identified at least one predetermined activity parameter and/or the at least one predetermined morphological anomaly of the isolated aquatic animal.

2-3. (canceled)

4. The system of claim 1, wherein the high DOF allows to continuously capture video from at least 125 cm³ of water.

5. (canceled)

6. The system of claim 1, wherein the housing is positioned about 5 cm away from the predetermined volume.

7. (canceled)

8. The system of claim 1, further comprising a light emitting diode (LED) backlit illumination panel, the illumination panel positioned between the housing and the predetermined volume,
wherein the illumination panel is submersible.

9. (canceled)

10. The system of claim 1, further comprising a semi-transparent diffuser, the diffuser positioned such that the housing and the diffuser are on opposing sides of the predetermined volume.

11-12. (canceled)

13. The system of claim 1, wherein the at least one predetermined activity parameter is selected from the group consisting of: cohort size; activity level; feeding performance; and food preference.

14. The system of claim 1, wherein the at least one predetermined morphological anomaly is selected from the group consisting of: abnormal body length; non-development of swim bladder; and skeletal aberrations.

15. The system of claim 1, wherein the processor is configured to apply an action classifier to the captured video to classify predetermined portions of the captured video into different predetermined events, the at least one predetermined activity comprising the different predetermined events,
wherein the action classifier is trained by the one or more neural networks.

16. The system of claim 15, wherein the predetermined events comprise swim events and strike events.

17. The system of claim 16, wherein the predetermined events comprise strike events, abrupt movements, non-routing swimming events and routing swimming events.

18. A machine vision method for larval aquatic animal rearing, the method comprising:
submersing in water a watertight housing containing a high-speed video camera comprising a lens, the lens exhibiting a high depth of field (DOF) and a microscopic resolution;
continuously capturing video of a predetermined volume of the water for a predetermined amount of time; and
applying one or more neural networks to the captured video to:
isolate individual aquatic animal within the video,
identify at least one predetermined activity parameter and/or at least one predetermined morphological anomaly of the isolated aquatic animal, and
output the identified at least one predetermined activity parameter and/or the at least one predetermined morphological anomaly of the isolated aquatic animal.

19-20. (canceled)

21. The method of claim 18, wherein the high DOF allows to continuously capture video from at least 125 cm³ of water.

22. (canceled)

23. The method of claim 18, further comprising positioning the housing about 5 cm away from the predetermined volume.

24. (canceled)

25. The method of claim 18, further comprising:
submersing a light emitting diode (LED) backlit illumination panel in the water, the illumination panel positioned between the housing and the predetermined volume; and
providing light from the submersed LED backlit illumination panel.

26. (canceled)

27. The method of claim 18, further comprising submersing a semi-transparent diffuser in the water, the diffuser positioned such that the housing and the diffuser are on opposing sides of the predetermined volume.

28-29. (canceled)

30. The method of claim 18, wherein the at least one predetermined activity parameter is selected from the group consisting of: cohort size; activity level; feeding performance; and food preference.

31. The method of claim 18, wherein the at least one predetermined morphological anomaly is selected from the group consisting of: abnormal body length; non-development of swim bladder; and skeletal aberrations.

32. The method of claim 18, wherein the processor is configured to apply an action classifier to the captured video to classify predetermined portions of the captured video into different predetermined events, the at least one predetermined activity comprising the different predetermined events,
wherein the action classifier is trained by the one or more neural networks.

33. The system of claim 32, wherein the predetermined events comprise swim events and strike events.

34. The system of claim 33, wherein the predetermined events comprise strike events, abrupt movements, non-routing swimming events and routing swimming events.
